(19) United States
(12) Patent Application Publication
(10) Pub. No.: US 2025/0290367 A1
(43) Pub. Date: Sep. 18, 2025

(54) Appliance Lid Hinge

(71) Applicant: Mansfield Engineered Components, LLC, Mansfield, OH (US)

(72) Inventor: James J. Collene, Bucyrus, OH (US)

(73) Assignee: Mansfield Engineered Components, LLC, Mansfield, OH (US)

(21) Appl. No.: 19/082,055

(22) Filed: Mar. 17, 2025

Related U.S. Application Data
(60) Provisional application No. 63/566,890, filed on Mar. 18, 2024.

(51) Int. Cl. E05F 3/20; D06F 39/14; D06F 58/20

(52) U.S. Cl. CPC E05F 3/20; D06F 39/14; D06F 58/20; E05Y 2201/266; E05Y 2201/416; E05Y 2201/474; E05Y 2201/638; E05Y 2900/312

(57) ABSTRACT

A lid hinge assembly for an appliance includes a base with a recess. A cam is rotatably supported in the recess and is adapted for rotation in first and second opposite angular directions. A spring is engaged between the base and the cam and biases the cam. The cam can include a camshaft rotatably seated in the recess, and the cam can include an enlarged head located on a first end of the camshaft on an inner axial end of the cam. The cam arm can project outwardly from a second end of the camshaft on a second outer end of the cam such that the central portion of the camshaft located between the enlarged head and the cam arm is seated in the recess. An optional damper can be located on the base and engaged by the cam to slow movement of the cam.

### CROSS-REFERENCE TO RELATED APPLICATION

This application claims priority from and benefit of the filing date of U.S. provisional application Ser. No. 63/566,890 filed Mar. 18, 2024, and the entire disclosure of said provisional application is hereby expressly incorporated by reference into the present application.

### BACKGROUND

Hinges for top-loading appliances such as washing machines and dryers may include a counterbalance mechanism that provides a desired counterbalance effect such that the pivoting dynamics of the appliance lid conform with the characteristics desired by the manufacturer and users. Such characteristics include some or all of the following features and others: (i) the lid requires no more than a select amount of force to open; (ii) the lid is self-supported in the fully opened position without external support; (iii) the lid is self-supported in a partially-opened position without external support; (iv) the lid closes from a select partially closed position by gravity without harsh slamming against the appliance body; and (v) the lid remains closed during normal operating conditions of the appliance. In addition, the lid hinge including the counterbalance mechanism must fit within in a limited mounting area of the appliance and be designed to operate even after prolonged and repeated exposure to water, soap, bleach, heat, vibration, and other harsh conditions. As such, a need has been identified for a new and improved appliance lid hinge assembly that meets the above-noted design requirements and others while providing structural and/or functional advantages over known designs.

### SUMMARY

In accordance with one aspect of the present development, a lid hinge assembly for an appliance includes a base configured to be attached to an associated appliance body. The base includes a recess, and a cam is rotatably supported in the recess and is adapted for rotation in first and second opposite angular directions relative to said base about a pivot axis, wherein said first and second opposite angular directions correspond respectively to opening movement of an associated appliance lid relative to the associated appliance body and closing movement of the associated appliance lid relative to the associated appliance body. A spring is operably engaged between the base and the cam. The spring includes a first end operably engaged with the base and a second end operably connected to a cam arm of the cam.

The cam can include a camshaft rotatably seated in the recess, and the cam can include an enlarged head located on a first end of the camshaft on an inner axial end of the cam.

The cam arm can project outwardly from a second end of the camshaft on a second outer end of the cam such that a central portion of the camshaft is located between the enlarged head and the cam arm.

The enlarged head located on the first end of said camshaft can be a first enlarged head and the cam can further include a second enlarged head located on the second end of the camshaft such that groove is defined between the first and second enlarged heads.

The base can include a transverse arcuate flange that defines an arcuate surface of said recess that is centered on said pivot axis and that extends for less than or equal to 180 degrees such that an open mouth of the recess is defined between opposite ends of the arcuate surface.

The inner end of the cam can include a non-circular aperture adapted to receive a non-circular tip of an associated hinge arm connected to the associated appliance lid.

The base can include a channel including: a main wall; upper and lower spaced-apart flanges projecting outwardly in a first direction from the main wall; a distal end spaced from the open recess and including a turned-in end wall portion.

The first end of the spring can be operably connected to the turned-in end wall portion of the main wall.

The turned-in end wall portion of the main wall and the upper and lower flanges of the channel can define a space in which the spring is located.

The first end of the spring can include a first hook including a linear segment at a free end of the first hook; the turned-in end wall portion of the main wall can includes an edge that includes a notch; and, the first hook can be engaged with the notch and the linear segment at the free end of the hook can lie flat against the turned-in end wall portion.

The turned-in end wall portion can be arranged at an oblique angle with respect to the main wall such that the turned-in end wall portion is arranged obliquely with respect to the main wall whereby an obtuse angle is defined between the turned-in end wall portion and the main wall when measured in the space defined between the upper and lower flanges and the turned-in end wall portion.

The spring can be a convex barrel spring.

The cam arm can include an aperture and the second end of the spring can include a hook that is engaged with the aperture of the cam arm.

The cam arm can include a stop face that contacts the channel or the associated appliance body to prevent angular movement of the cam in the first angular direction beyond a second angular position.

The cam can comprise a one-piece polymeric structure.

The main wall and the upper and lower spaced-apart flanges of the base can define a spring-receiving space in which the spring is located, wherein the main wall of the base can include at least one of: (i) a recess defined in an internal side that faces the spring to provide space for said spring adjacent said main wall; (ii) open slot that extends through the main wall adjacent the spring.

The lid hinge assembly can further include a damper located on the base that is engaged by the cam to slow movement of the cam in the second angular direction corresponding to said pivoting closing movement of the associated appliance lid.

The damper can include a cylinder body that is movably connected to the base, the base can include a damper-receiving housing including a bore in which the damper cylinder body is slidably positioned, and the damper-receiving housing can include either: (i) a metallic housing structure defined as part of a one-piece structure together with the base; (ii) a polymeric housing connected to the base; (iii) one or more clips, rivets, bosses, or any other structure(s) connected to and/or formed as part of the channel and positioned to hold the damper D in its operative position on or relative to the base.

The cam can engage the damper in an engagement position of the cam that is located angularly between a first operative position of the cam corresponding to a fully closed position of the associated appliance lid and a second operative position of the cam corresponding to a fully opened position of the associated appliance lid, wherein angular movement of the cam in the second angular direction from the second operative position toward the first operative position is unaffected by the damper for at least part of an angular distance traveled by the cam from the second operative position toward the first operative position.

The damper can include a rod that projects outwardly from a rod end and that is abutted with a wall of the damper housing that includes an indentation in which a tip of said rod is received to locate said rod and maintain the rod in alignment within the damper housing bore.

### BRIEF DESCRIPTION OF DRAWINGS

FIG. 1 shows a top-loading appliance such as a clothes washing machine or another appliance including a least one lid hinge assembly provided in accordance with an embodiment of the present development.

FIG. 2 shows the lid of the appliance of FIG. 1.

FIGS. 3A & 3B are partial section views of an upper portion of the appliance body and lid and show an outer side of the first lid hinge assembly, with the lid hinge assembly in a first operative position or lid closed position (FIG. 3A) and a second operative position or lid fully opened position (FIG. 3B).

FIGS. 4A & 4B are front isometric views that correspond respectively to FIGS. 3A & 3B in terms of the operative state of the lid hinge assembly but show the lid hinge assembly by itself.

FIG. 5A is a side view of an opposite, inner side of the first lid hinge assembly shown in FIGS. 3B & 4B.

FIG. 5B provides an exploded isometric view of the first lid hinge assembly of FIG. 5A.

FIG. 6 provides an outer side isometric view of an alternative lid hinge assembly.

FIG. 7 illustrates an outer side isometric view of another alternative lid hinge assembly, with the cam located in a neutral or shipping position.

FIG. 7A is a partial, enlarged side view of the lid hinge assembly of FIG. 7.

FIGS. 8A, 8B, & 8C are similar to FIG. 7A but show the lid hinge assembly in second operative (fully opened), first operative (fully closed), and intermediate (partially opened/closed) positions, respectively.

FIG. 9 is a partial view of an alternative embodiment of a lid hinge assembly.

### DETAILED DESCRIPTION

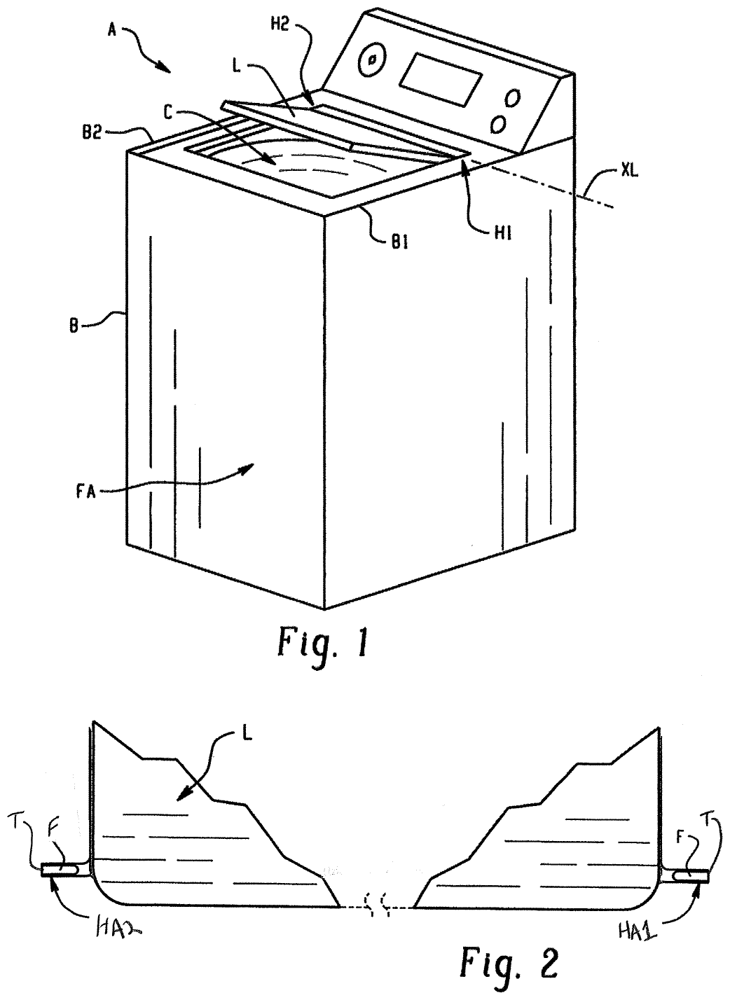

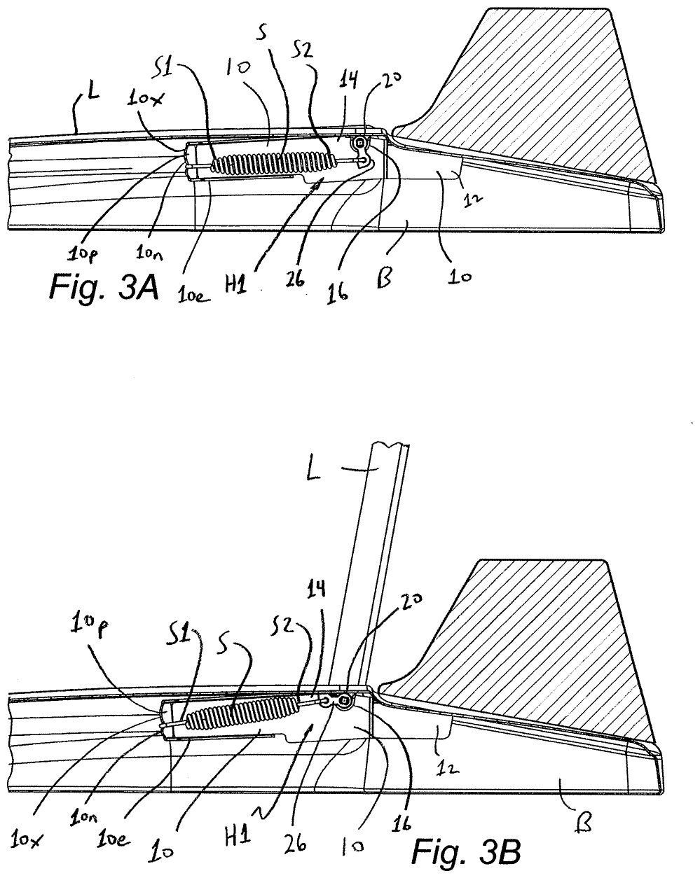

FIG. 1 shows a top-loading appliance A such as a clothes washing machine or dryer or another appliance. The appliance A includes a body B and a lid L that is pivotally connected to the body B and adapted for pivoting movement relative to the body about a pivot axis XL between a closed position, where the lid L is in contact with the body B and covers or blocks access to a chamber C located inside the body, and an opened position, in which the lid L is moved to a position where it uncovers or opens and allows access to the chamber C. FIG. 1 shows the lid L in an intermediate or partially opened position located between the closed position (FIG. 3A) and a fully opened position (FIG. 3B). In the fully opened position, the lid L is pivoted a maximum distance away from the body B and can be self-supported in such position, which can be a position where the lid L is pivoted at least 85 degrees or at least 90 degrees or more than 90 degrees (as shown in FIG. 3B) away from the fully closed position.

The lid L is operatively secured to the body B for such pivoting movement about the pivot axis XL by a first (right) lid hinge assembly H1 located adjacent and connected to a first (right) lateral side of the lid L/body B and a second (left) lid hinge assembly H2 located adjacent and connected to a second (left) lateral side of the lid L/body B. At least one of the first and second hinge assemblies H1, H2 can be constructed in accordance with an embodiment of the present invention, or both of the first and second hinge assemblies H1, H2 can be constructed in accordance with an embodiment of the present invention. In one example, the first and second hinge assemblies H1,H2 can be identical to each other for ambidextrous mounting on either the first (right) or second (left) lateral side of the appliance body B. In another example, as shown herein, the first and second hinge assemblies H1,H2 can be mirror images of each other or otherwise distinct with respect to each other so that each hinge assembly H1, H2 is particularly configured for mounting on only the first (right) or second (left) lateral side of the appliance body B.

FIG. 2 shows one example of a lid L by itself. First (right) and second (left) hinge arms HA1, HA2 are connected to and/or otherwise located respectively on opposite first and second lateral sides of the lid L, respectively. The first and second hinge arms HA1, HA2 are adapted for respective operative engagement with the first and second hinge assemblies H1, H2 to operatively and pivotally secure the lid L to the appliance body B. Each hinge arm HA1,HA2 comprises a wire form or other projecting arm structure secured to or otherwise provided as part of the lid L and comprising a tip T that projects transversely outward away from the lid. The tips T are aligned with each other and lie coincident with the pivot axis XL when the lid L is operatively installed on the body B. Each tip T can include one or more flats F or can be otherwise provided with a non-circular cross-section or be otherwise configured for non-rotatable engagement with the respective first and second lid hinge assemblies H1,H2 connected to the appliance body B as described below for pivotally securing the lid L to the body B. Although the first and second hinge arms HA1, HA2 are described as being part of the lid L, the first and second hinge arms HA1, HA2 can alternatively be provided as part of and/or connected to the first and second hinge assemblies H1,H2, respectively, and be adapted to be connected to the lid L to pivotally connect the lid to the body B as is described in further detail below.

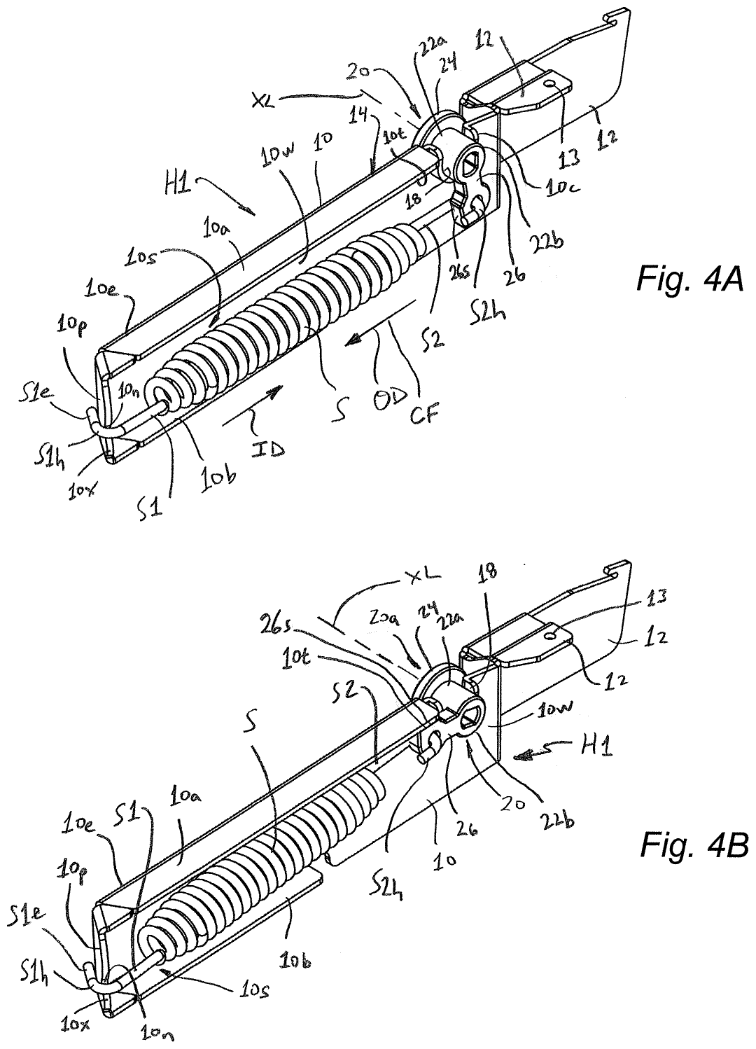

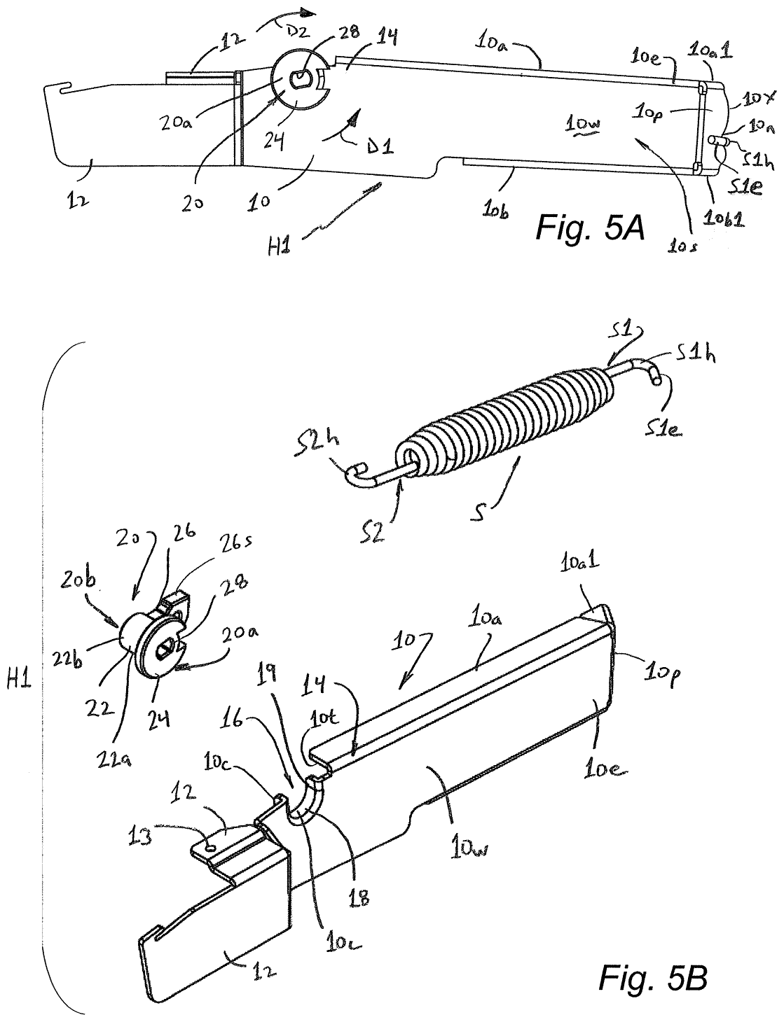

FIGS. 3A & 3B are partial section views of an upper portion of the appliance body B and show an outer side of the first lid hinge assembly H1. FIG. 3A shows the first lid hinge assembly H1 in a first operative configuration or position corresponding to the fully closed position of the appliance lid L, and FIG. 3B shows the first lid hinge assembly H1 in a second operative configuration or position corresponding to the fully opened position of the appliance lid L. FIGS. 4A & 4B correspond respectively to FIGS. 3A & 3B but are isometric views that show the lid hinge assembly H1 by itself in its first and second operative configurations. FIG. 5A is a side view of an opposite, inner side of the first lid hinge assembly H1 shown in FIG. 4B, and FIG. 5B provides an exploded perspective view of the first lid hinge assembly H1 of FIG. 5A.

In one embodiment, as noted above, the second hinge assembly H2 can be constructed as a mirror image of the illustrated first hinge assembly H1. Alternatively, the illustrated hinge assembly H1 can be made ambidextrous so that it can be installed and function as either the first hinge assembly H1 or the second hinge assembly H2. To simplify the present description, the present development is described with reference to the illustrated first hinge assembly H1, but those of ordinary skill in the art will recognize that the second hinge assembly H2 can have a corresponding structure that is a mirror image of the first hinge assembly H1 or that otherwise corresponds to the first hinge assembly H1.

Referring to all of FIGS. 3A-5B, the hinge assembly H1 comprises a base such as a channel 10 that can be defined as a unitary stamped metal structure that can include one or more mounting flanges 12 (FIGS. 4A & 4B) that can comprise one or more slots, apertures or other openings 13 that are adapted to receive a rivet, screw or like fastener for operatively securing the channel 10 to the appliance body B. Alternatively, the flange(s) 12 and/or other parts of the channel 10 can be adapted to directly engage a mating slot or other structure of the appliance body B to secure the channel 10 fixedly in its operative position on the appliance body B without any fasteners. The number and location of the mounting flange(s) 12 and any provided slots or apertures 13 will vary depending upon the particular appliance body B on which the channel 10 is configured to be mounted. Alternatively, the channel 10 comprises a polymeric (plastic) structure and/or is assembled from multiple pieces of metal and/or polymeric material and/or another material. The term “channel” is not intended to imply any particular shape or cross-section, and the illustrated base/channel 10 is only one example of a suitable shape.

The lid hinge assembly H1 comprises a cam 20 rotatably supported on or otherwise rotatably engaged with the base/channel 10. In the illustrated non-limiting example, an upper portion 14 of the channel 10 comprises an open recess 16 that includes an arcuate cam support surface 18 such as the illustrated cylindrical surface 18, which is centered on the pivot axis XL, on which the cam 20 is rotatably supported for rotation relative to the channel 10 in first and second opposite angular directions D1,D2 (see FIG. 5A) about the pivot axis XL. The first angular direction D1 can correspond to movement of the appliance lid L in an opening direction toward its fully opened position (FIGS. 3B, 4B, 5A) and the opposite second angular direction D2 can correspond to movement of the appliance lid L in a closing direction toward its closed position (FIGS. 3A, 4A). The arcuate cam support surface 18 can extend for less than or equal to 180 degrees so as to define an open mouth 19 (FIG. 5B) between its opposite ends through which the cam 20 is operatively installed into the recess 16. The arcuate cam support surface 18 can be defined by a transverse arcuate flange 10c that projects perpendicularly outwardly from a main wall 10w of the channel 10 in a first or outer direction. The cam 20 can comprise a one-piece polymeric (plastic) structure such as an injection molded or otherwise formed monolithic polymeric structure that facilitates the formation of a cam 20 with the illustrates structure as described in more detail below, or the cam can be cast or otherwise formed from metal or another material.

The base/channel 10 can also include upper and lower flanges 10a, 10b that also project transversely outward from the main wall 10w in the first/outer direction and that can be arranged perpendicular to the main wall 10w and parallel and spaced-apart relative to each other so as to define a spring-receiving space 10s there between. The main wall 10w extends between and interconnects the upper and lower flanges 10a, 10b. An outer or distal end 10e of the channel 10 that is spaced from the open recess 16 comprises a turned-in end portion 10p of the main wall 10w that extends away from the main wall 10w in the first/outer direction to close an end of the spring receiving space 10s (the upper and lower flanges 10a, 10b can be notched as shown herein to facilitate formation of the turned-in end portion 10p without folding of the upper and lower flanges 10a, 18b). The turned-in end wall portion 10p of the main wall 10w extends between first and second parallel, spaced-apart end portions 10a1,10b1 of the upper and lower flanges 10a, 10b. In one example, as shown herein, the turned-in end wall portion 10p of the main wall 10w is arranged obliquely with respect to an inner portion of the main wall 10w located between the turned-in end portion 10p and the recess 16 such that an obtuse angle of more than 90 degrees but less than 180 degrees is defined between the turned-in end wall portion 10p and the main wall 10w when measured in or through the space 10s on the outer side of the channel 10.

The turned-in end wall portion 10p is configured to be operably engaged by or operably connected with an outer end S1 of a counterbalance spring S of the lid hinge assembly H1. In the illustrated example, an outer edge 10x of the turned-in end wall portion 10p extends between and interconnects the flange end portions 10a1, 10b1 and defines or otherwise includes a spring anchor location such as a notch 10n for receiving and being directly or indirectly engaged by and/or connected to the first or outer end S1 of the spring S. Alternatively, the turned-in end wall portion 10w1 can include an aperture and/or other structure(s) for being engaged by the outer end S1 of the spring S to provide a spring anchor location on the channel 10.

With particular reference to the exploded view of FIG. 5B, the cam 20 comprises an inner axial end 20a and an opposite outer axial end 20b. The cam further comprises a cylindrical camshaft 22 that is rotatably engaged with the arcuate cam support surface 18 of the open recess 16. The cam 20 can include a radially enlarged head 24 at a first or inner end 22a of the camshaft 22 and can include a radially projecting spring arm or cam arm 26 at an opposite outer axial end 22b of the camshaft 22. When the cam 20 is operatively seated in the recess 16, a central portion of the camshaft 22 between the enlarged head 24 and the cam arm 26 is rotatably engaged with the arcuate cam support surface 18, and the cam 20 is axially captured in the recess 16 by the enlarged head 24 on the inner axial end 20a and the projecting cam arm 26 on the opposite outer axial end 20b such that the cam 20 cannot exit the recess 16 by axial movement along the pivot axis XL.

At least the inner axial end 20a of the cam 20 is adapted to be operably non-rotatably connected to one of the lid hinge arms HA1, HA2 such that the hinge arm HA1, HA2 and the camshaft 22 rotate together about the pivot axis XL when operably connected. When the lid hinge assembly H1 is made ambidextrous, both the inner and outer axial ends 20a,20b of the cam 20 can be adapted to be operably and non-rotatably connected to one of the lid hinge arms HA1, HA2 such that the lid hinge assembly H1 can be used as either the first or second lid hinge assembly H1,H2. In the illustrated embodiment, at least the inner axial end 20a of the cam 20 (and optionally both the inner and outer axial ends 20a,20b) includes a non-circular hinge arm engagement aperture 28 that non-rotatably receives and mates with the tip T of an associated lid hinge arm HA1, HA2 in a non-rotatable or keyed manner, but other non-rotatable mating connections between a hinge arm HA1, HA2 and the cam 20 can be used. When the tip T of an appliance lid hinge arm HA1, HA2 is mated with the hinge arm engagement aperture 28 of the cam 20, the cam 20 rotates in the recess 16 in response to pivoting movement of the lid L about the pivot axis XL in the first and second opposite angular directions D1,D2 to and between its opened and closed positions. As noted above, the first and second hinge arms HA1, HA2 can be connected to and/or formed respectively as a part of the first and second hinge assemblies H1,H2 such as by being connected to and/or formed as part of the cam 20 rather than by being provided as part of the lid L, in which case the lid L is pivotally connected to the appliance body B when the lid L is connected to the first and second hinge arms HA1, HA2.

As noted above, the lid hinge assembly H1 comprises a counterbalance spring S. The spring S is operably engaged between the channel 10 and the cam 20 and resiliently biases the cam 20 toward a neutral angular position located angularly between a first angular position of the cam 20 corresponding to the appliance lid L being fully closed (FIGS. 3A & 4A) and a second angular position of the cam 20 corresponding to the appliance lid L being fully opened (FIGS. 3B & 4B). As such, the spring S biases the cam 20 in the first (opening) angular direction D1 from its first operative or first angular (lid fully closed) position toward the neutral position and also biases the cam 20 in the opposite second (closing) angular direction D2 from its second operative or second angular (lid fully opened) position toward the neutral position. The neutral position is reached when the spring S assumes its shortest possible length as operatively installed. Thus, the cam 20 is rotatable in the first angular direction D1 about the pivot axis XL from its first operative (lid closed) position toward and into a second operative position corresponding to the fully opened position of the appliance lid L, and the cam 20 is also selectively rotatable in the opposite second angular direction D2 about the pivot axis XL from the second operative (lid opened) position toward and into the first operative position corresponding to the closed position of the appliance lid L (FIGS. 3A, 4A). The cam 20 is rotated in the second (lid closing) direction D2 against the biasing force of the spring S for at least part of the angular distance between the second operative (lid opened) and first operative (lid closed) positions, i.e., between the neutral position and the first operative (lid closed) position. In the illustrated embodiment, the cam 20 is also rotated in the first (lid opening) direction D1 against the biasing force of the spring S between the neutral position and the second operative (lid opened) position.

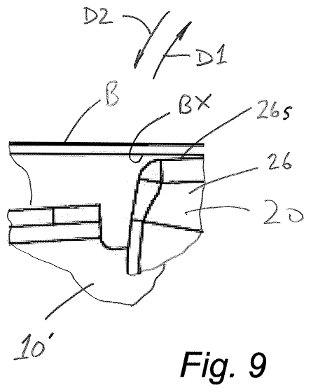

In the illustrated non-limiting example, the spring S is a coil spring including opposite first (outer) and second (inner) ends S1,S2. The first end S1 of the spring S can be operably engaged with or operably connected to the channel 10, such as by being engaged with or connected to the turned-in end wall portion 10p as described above, and the opposite second end S2 of the spring S can be operably engaged with or operably connected to the cam 20 for biasing the cam 20 such as by being engaged with or connected to the cam arm 26 of the cam. As shown herein, the first end S1 of the spring S includes a first hook S1h configured to receive the outer edge 10x of the turned-in end wall 10p so that the first hook S1h is seated in the notch 10n and so that a projecting linear segment S1e at the free end of the hook S1h lies flat against the turned-in end wall 10p. In the illustrated embodiment, the opposite second end S2 of the spring S includes a second hook S2h that is engaged with the cam arm 26, such as by being received in an aperture 26a defined in the cam arm 26 or otherwise engaged with the cam arm 26 such as by being received in an open recess or hook structure of the cam arm 26 or otherwise connected to the cam arm 26. As such, the spring S operates as a tension spring that resiliently pulls the cam arm 26 in an outward direction OD (FIG. 4A) toward the turned-in end wall portion 10p as the spring S naturally shortens toward its free length, and the spring S can be resiliently elongated in an opposite inward direction ID when the appliance lid L is moved toward its closed position causing the cam 20 to rotate in the second angular direction D2 so that the cam arm 26 extends the spring S as the cam 20 rotates from its neutral position toward its first position, whereby the spring S exerts a biasing force or counterbalance force CF in the outward direction OD on the cam arm 26. This counterbalance force CF assists in opening movement of the appliance lid L and slows movement of the appliance lid in the closing direction D2 to reduce the tendency of the lid L to slam into or contact the body B at high speed upon reaching the closed position. As mentioned, the spring S can also be resiliently elongated in the inward direction ID when the appliance lid L is moved toward its fully opened position when the cam 20 rotates beyond its neutral position toward its second operative (lid opened) position whereby the spring biasing force CF can slow opening movement of the lid L in the second direction D2 as it approaches its fully opened position. The counterbalance force CF of the spring S exerted on the cam 20 through the cam arm 26 also acts to retain the cam 20 in the open recess 16 of the channel 10 and prevent the cam 20 from exiting the open recess 16 via mount 19. Contact between the appliance lid L and the appliance body B in the closed position of the lid L limits further rotation of the cam 20 in the second angular direction D2. In the opposite first angular direction D1, rotation of the cam 20 can be limited when a stop face 26s of the cam arm 26 contacts the channel 10, such as a channel stop 10t defined by part of the upper flange 10a, when the lid L is located in its fully opened position as shown in FIGS. 3B & 4B to prevent rotation of the cam 20 in the first angular direction D1 beyond the second angular position corresponding to the fully opened position of the appliance lid L. Alternatively, depending on the particular configuration and structure of the channel 10, the stop face 26s of the cam arm 26 can contact a stop surface BX that is provided as part of the appliance body B rather than the channel stop 10t (i.e., the channel stop 10t can be omitted as shown for the alternative channel 10′ in FIG. 9) such that the fully opened position of the appliance lid L and the second operative position of the cam 20 are defined when the stop face 26s of the cam arm 26 or other part of the cam 20 contacts the body stop surface BX or other part of the appliance body B. The second angular position of the cam 20 corresponding to the fully opened position of the appliance lid L can be set by altering the location of the channel stop 10t by bending or otherwise forming the channel upper flange 10a (or by altering the position of the body stop BX in the embodiment of FIG. 9) and/or by altering the position or configuration of the stop face 26s of the cam arm 26.

Although the spring S is shown with its opposite ends S1,S2 being directly connected respectively to the channel 10 and cam arm 26 via first and second hooks S1h, S2h, those of ordinary skill in the art will recognize that either or both of the first and second spring ends S1, S2 can alternatively be indirectly operatively connected to the channel 10 and/or cam arm 26 such as by way of an intermediate linkage, pin, and/or other structure(s). Furthermore, one or both of the first and second hooks S1h, S2h of the spring S can be replaced by any other suitable structure such as a closed loop or other structure(s) that allow the spring S to be connected directly or indirectly to the channel 10 at the spring first end S1 and to the cam 20 at the spring second end S2.

As shown herein, the spring S is a helically wound tension coil spring, but other types of springs can be used. The illustrated spring S comprises a convex barrel spring shape that can provide a progressively increasing counterbalance force CF as the spring S elongates during pivoting movement of the appliance lid L in the second or closing angular direction D2.

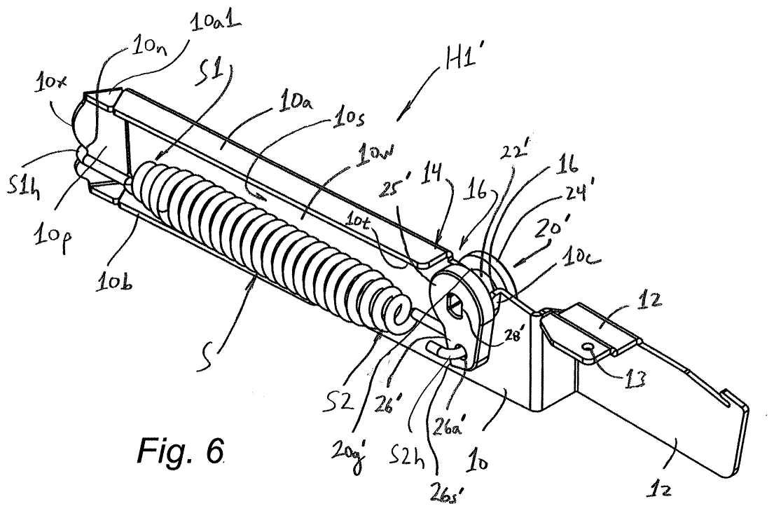

FIG. 6 provides an outer side isometric view of an alternative lid hinge assembly H1′ that is identical to the lid hinge assembly H1 except as otherwise shown and/or described. Certain like components of the lid hinge assembly H1′ that correspond to components of the lid hinge assembly H1 are identified with the same reference numbers and/or reference characters or with reference numbers/characters that include a primed (′) designation and such components are not all necessarily described here again. The lid hinge assembly H1′ comprises an alternative cam 20′ that is similar to the cam 20 and comprises a cylindrical camshaft 22′ that is rotatably engaged with the arcuate cam support surface 18 of the open recess 16. The cam 20′ includes a first radially enlarged head 24′ at a first or inner end 20a′ also includes a radially projecting cam arm 26′ at an opposite outer axial end 20b′. Unlike the cam 20, the alternative cam 20′ further comprises a second radially enlarged head 25′ located on the outer axial end 20b′. The second radially enlarged head 25′ can be provided as part of the cam arm 26′ as shown where the second radially enlarged head 25′ is part of an inner end of the cam arm 26′ that is connected to the outer axial end of the camshaft 22′. An outer end of the cam arm 26′ spaced from the camshaft 22′ can include an aperture 26a′ or other structure for being engaged by the hook S2h at the second end of the spring S2. The first and second radially enlarged heads 24′,25′ are thus located on opposite axial ends of the camshaft 22 such that a central portion of the camshaft 22′ is located between the first and second radially enlarged heads 24′,25′. The cam 20′ comprises a groove 20g′ located on the central portion of the camshaft 22 and defined between the first and second enlarged heads 24′,25′. The groove 20g′ can be defined by and between the first and second radially enlarged heads 24′,25′ and the central portion of the camshaft 22′. The groove 20g′ closely receives the transverse arcuate flange 10c of the channel 10 when the cam 20′ is operably seated in the open recess 16 so that the cam 20′ is axially captured in the open recess 16 of the base/channel 10 and so that axial movement of the cam 20′ is limited by the width of the groove 20g′ due to contact between the main wall 10w of the channel 10 and the first enlarged head 24′ on an inner side of the lid hinge assembly H1′ and due to contact between the transverse arcuate flange 10c of the channel 10 and the second enlarged head 25′ on an outer side of the lid hinge assembly H1′. As with the cam 20, the cam 20′ can be manufactured as a one-piece injection molded or otherwise formed monolithic polymeric structure.

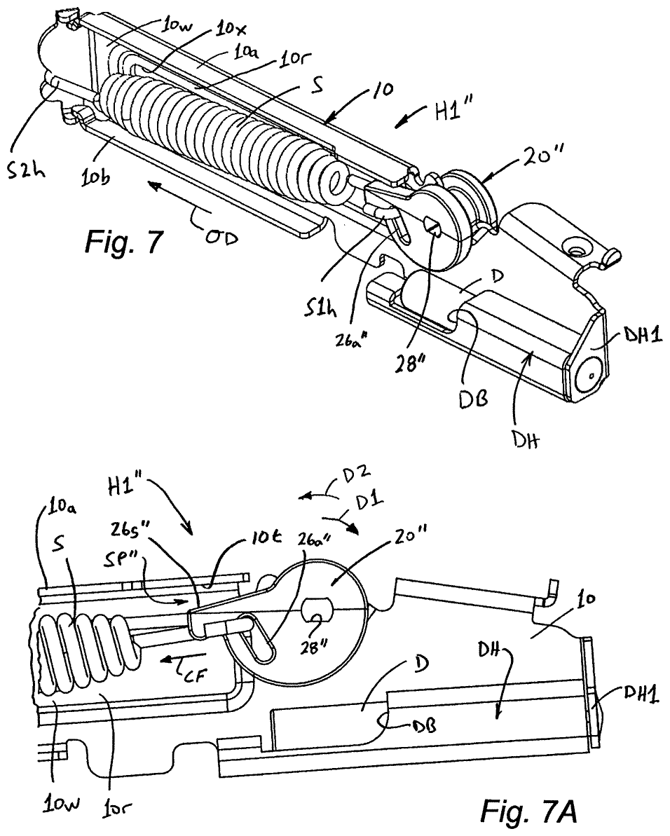

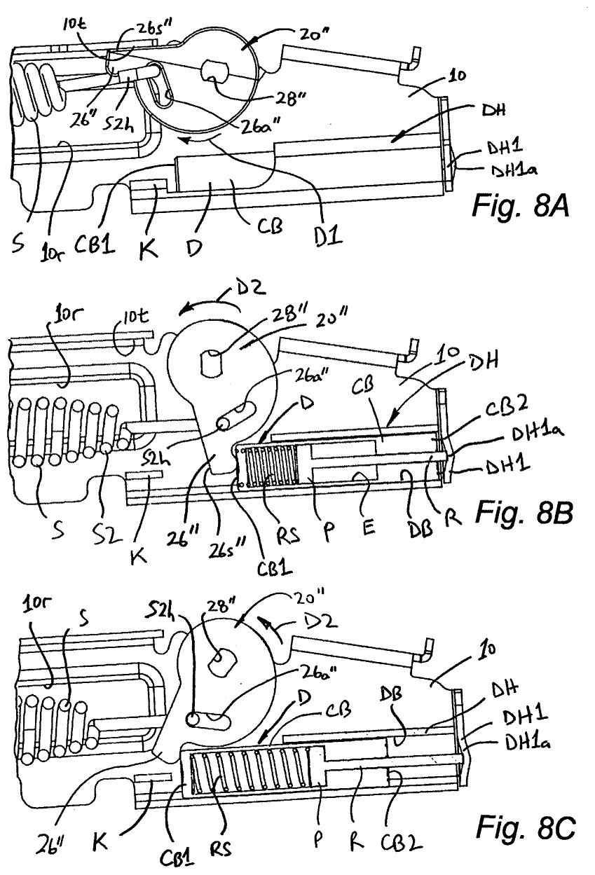

FIG. 7 illustrates an outer side isometric view of an alternative lid hinge assembly H1″ that is identical to the lid hinge assembly H1′ except as otherwise shown and/or described. Certain like components of the lid hinge assembly H1″ that correspond to components of the lid hinge assembly H1′ are identified with the corresponding reference numbers and/or reference characters or with reference numbers/characters that include a double primed (″) designation rather than a single primed (′) designation and such components are not all necessarily described here again. As shown in the variation of FIG. 7 and also in the enlarged view of FIG. 7A, the cam aperture 26a″ of the cam 20″ can be formed as an elongated slot (rather than the circular aperture 26a′ of the lid hinge assembly H1′) to facilitate insertion and removal of the second hook S2h. Also, for either the hinge assembly H1′ or the hinge assembly H1″ the aperture/slot 26a′/26a″ can be located such that when the cam 20′/20″ is unrestrained and the spring S can assume its shortest operative position, the cam 20′/20″ is located in a neutral or shipping position as shown in FIG. 7 and the enlarged partial view of FIG. 7A where the cam 20′/20″ is located angularly between its first operative (lid opened) position and its second operative (lid closed) position such that backlash space SP″ is defined between the stop face 26s″ of the cam arm 26″ and the channel stop 10t. As such, those of ordinary skill in the art will recognize that movement of the appliance lid L further in the direction D1 to its fully opened position (see FIG. 8A) from the neutral position of the cam 20′/20″ will result in elongation of the spring S against the spring counterbalancing force CF to slow or restrain movement of the cam 20′/20″ and the lid L in the first direction D1 as the lid L approaches its fully opened position and the cam 20′/20″ approaches its second operative position to prevent harsh opening of the lid L and harsh contact between the cam arm stop face 26s″ and the channel stop 10t or a stop BX on the body B if the optional channel stop 10t is omitted. As mentioned above, the counterbalance force CF of the spring S in the outward direction OD also slows or restrains movement of the cam 20′/20″ and lid L in the second direction D2 as the lid L moves toward its fully closed position and the cam 20′/20″ approaches its first operative position (see FIG. 8B) to slow movement of the lid L and also provides assistance to lifting the lid L when the lid is moved toward its opened position. In the illustrated example, the neutral position of the cam 20″ is closer to the second operative position (lid-opened position) of the cam 20′/20″ as compared to the first operative position (lid-closed position) of the cam 20′/20″ and preferably is within 10 degrees (10°) inclusively or less of the second operative (lid-opened) position of the cam 20′/20″ such that movement of the cam 20′/20″ and lid L in the first direction D1 is resisted by the spring S for only the final stages of the lid opening process while the counterbalance force CF of the spring S otherwise assists movement of the cam 20′/20″ and lid L in the first direction D1.

FIGS. 7 & 7A also show that the lid hinge assembly H1″ comprises (and the lid hinge assemblies H1, H1′ can optionally comprise) an optional damper D connected to or otherwise located on the channel or other base 10. For an appliance A as shown in FIG. 1, either one or both of the lid hinge assemblies H1,H2 can be provided with an optional damper D, an example of which is described here with reference to FIGS. 7-8C. The damper D is adapted to be engaged by the cam arm 26″ or other part of the cam 20″ to slow movement of the cam 20″ in the second angular direction D2 corresponding to closing movement of the associated appliance lid L.

The damper D can comprise a cylinder body CB that is slidably or otherwise movably connected to the channel 10. In the illustrated example, the channel 10 comprises a damper-receiving housing DH including a damper bore DB (see also FIGS. 8B, 8C) in which said damper cylinder body CB is slidably or movably positioned for linear reciprocal movement relative to the channel 10. The damper D can be captured in the damper bore DB by an end wall DH1 that closes a first or inner end of the damper bore DB and by a keeper K such as crimped tab or other portion of the channel 10 comprising a portion of the channel 10 that is folded upon itself to partially obstruct an open second of outer end of the damper bore DB sufficiently such that the damper D cannot exit the damper bore DB by movement of the cylinder body CB along a purely linear path but can be removed for replacement by non-linear movement of the cylinder body CB relative to the channel 10 over the crimped tab portion or other keeper K. The keeper K can alternatively comprise a clip, rivet, boss, or any other structure connected to and/or formed as part of the channel 10 and positioned to capture the cylinder body CB in the damper bore DB.

In the illustrated example, the damper housing DH is provided as part of a one-piece construction as part of the one-piece metallic channel 10, in particular by a portion of the metallic channel 10 that is formed into the tubular damper housing DH including the damper bore DB. Alternatively, the damper housing DH can be provided by a separate structure from the base/channel 10 that is connected to the channel/base 10, such as a polymeric (plastic) damper housing body that is connected to the channel 10 by one or more rivets or other fasteners and in which the damper bore DB is defined. The damper housing DH can alternatively comprise one or more clips, rivets, bosses, or any other structure(s) connected to and/or formed as part of the channel and positioned to hold the damper D in its operative position on or relative to the base/channel 10.

Referring particularly to FIG. 8C, the cam arm 26″ or other part of the cam 20″ engages and activates the damper D in an engagement position of the cam 20″ that is an angular position of the cam 20″ that is located between the second operative position of the cam 20″ (FIG. 8A) corresponding to the fully opened position of the associated appliance lid L an the first operative position of the cam 20″ (FIG. 8B) corresponding to the fully closed position of the associated appliance lid L. More particularly angular movement of the cam 20″ in the second angular direction D2 from the second operative position toward the first operative position is unaffected by the damper D for at least part of the angular distance traveled by the cam 20″ from the second operative position (FIG. 8A) toward the first operative position (FIG. 8B) until the cam 20″ reaches the engagement position (FIG. 8C) where the cam arm 26″ or other part of the cam 20 first contacts and activates the damper D such that movement of the cam 20″ is affected by the damper D. In the illustrated example, the cam arm 26″ contacts a first or closed end CB1 of the cylinder body CB of the damper D in the engagement position and, upon further angular movement of the cam 20″ in the second direction D2, the cam arm 26″ urges the cylinder body CB inward into the damper bore DB toward the first end wall DH1 of the damper housing DH.

As shown in the section view of FIG. 8C, the cylinder body CB can comprise a cylinder bore E in which a piston P is slidably located. A rod or piston rod R is connected to the piston P and projects outwardly from the bore E at an inner/second or rod end CB2 of the cylinder body CB and is abutted against a structure that is part of and/or connected to the base/channel 10 and fixed in position relative to the base/channel 10 such as the end wall DH1 of the damper housing DH. A damping fluid such as hydraulic oil, air, or another fluid is located in the cylinder bore E and damps inward movement of the piston P and the piston rod R in the bore E toward the closed end CB1 of the cylinder body CB from an extended position (FIG. 8C) toward its retracted position (FIG. 8B) where the piston P and rod R are moved inwardly in the bore E through the damping fluid away from the second/rod end CB2 and toward the first/closed end CB1 of the cylinder body CB such that the rod R is withdrawn into the bore E relative to the rod end CB2 of the cylinder body CB as compared to the extended position when the cylinder body CB is pushed by the cam arm 26″ toward the end wall DH1 of the damper housing DH relative to the piston P which is restrained by contact between the rod R and the damper housing end wall DH1. The damper housing end wall DH1 can include an indentation DH1a (FIGS. 8B,8C) that receives an outermost tip or distal end of the rod to center and locate the rod R and maintain the rod R in alignment within the damper housing bore DB. Alternatively, the damper D can be installed in an opposite orientation with the cylinder body CB abutted with the end wall DH1 of the damper housing DH or other part of the channel 10 or structure connected to the channel 10 and with the piston rod R projecting outwardly from the damper bore DB and located to be engaged by the cam arm 26″ or other part of the cam 20″ to urge the piston P through the bore E including the damping fluid from its extended position toward the first/closed end CB1 of the cylinder body CB toward its retracted position to activate the damper D. The damper D can include a return spring RS located in the cylinder bore R that exerts a return force on the piston P or rod R to return the piston P and rod R to the extended position of FIG. 8C. Alternatively, the return spring RS can be located external to the cylinder body CB and be positioned coaxially about the piston rod R between the rod end CB2 of the body CB and a stop located on the rod R to urge the piston P and rod R toward the extended position. Those of ordinary skill in the art will recognize that the piston P and rod R are also located in the extended position in FIG. 8A because the damper D is unaffected by the cam 20″ and the return spring RS will move the piston P and rod R to their extended positions.

The embodiment H1″ of FIGS. 7 to 8C also shows that portions of the main wall 10w can optionally be removed or opened to reduce weight and/or provide clearance for the spring S. A shown, the main wall 10w comprises an elongated slot or other clearance opening 10x (FIG. 7) that extends along at least part of the length of the spring S to provide clearance for the spring and/or to reduce weight of the base/channel 10. The main wall 10w can be embossed or otherwise formed to include a recess 10r oriented toward the spring S to provide added space or clearance for the spring S to prevent or at least reduce contact between the spring S and the main wall 10w. If both the recess 10r and clearance opening 10x are provided, the clearance opening 10x can be located entirely within the recess 10r such that the recess 10r surrounds the clearance opening 10x.

The development has been described with reference to preferred embodiments, but it is not intended that the invention be limited to such preferred embodiments. Modifications and alterations will occur to those of ordinary skill in the art to which the invention pertains, and it is intended that the claims be construed as broadly as possible while maintaining their validity in order to encompass all such modifications and alterations.

1. A lid hinge assembly for an appliance, said lid hinge assembly comprising:
a base configured to be attached to an associated appliance body, said base comprising a recess;
a cam rotatably supported in said recess and adapted for rotation in first and second opposite angular directions relative to said base about a pivot axis, wherein said first and second angular directions correspond respectively to opening movement of an associated appliance lid relative to the associated appliance body and closing movement of the associated appliance lid relative to the associated appliance body;
a spring operably engaged between the base and the cam, said spring comprising a first end operably engaged with the base and a second end operably connected to a cam arm of the cam.

2. The lid hinge assembly as set forth in claim 1, wherein the cam comprises a camshaft rotatably seated in said recess, said cam comprising an enlarged head located on a first end of the camshaft on an inner axial end of the cam.

3. The lid hinge assembly as set forth in claim 2, wherein said cam arm projects outwardly from a second end of the camshaft on a second outer end of the cam such that a central portion of the camshaft is located between the enlarged head and the cam arm.

4. The lid hinge assembly as set forth in claim 3, wherein said enlarged head located on said first end of said camshaft is a first enlarged head and wherein said cam comprises a second enlarged head located on the second end of the camshaft such that groove is defined between the first and second enlarged heads.

5. The lid hinge assembly as set forth in claim 4, wherein the base comprises a transverse arcuate flange that defines an arcuate surface of said recess that is centered on said pivot axis and that extends for less than or equal to 180 degrees such that an open mouth of said recess is defined between opposite ends of the arcuate surface.

6. The lid hinge assembly as set forth in claim 5, wherein the inner end of the cam includes a non-circular aperture adapted to receive a non-circular tip of an associated hinge arm connected to the associated appliance lid.

7. The lid hinge assembly as set forth in claim 3, wherein the inner end of the cam includes a non-circular aperture adapted to receive a non-circular tip of an associated hinge arm connected to the associated appliance lid.

8. The lid hinge assembly as set forth in claim 1, wherein said base comprises a channel including:
a main wall;
upper and lower spaced-apart flanges projecting outwardly in a first direction from the main wall;
a distal end spaced from the open recess and including a turned-in end wall portion.

9. The lid hinge assembly as set forth in claim 8, wherein the first end of the spring is operably connected to the turned-in end wall portion of the main wall.

10. The lid hinge as set forth in claim 9, wherein the turned-in end wall portion of the main wall and the upper and lower flanges of the channel define a space in which said spring is located.

11. The lid hinge assembly as set forth in claim 9, wherein:
said first end of said spring comprises a first hook including a linear segment at a free end of the first hook;
said turned-in end wall portion of the main wall includes an edge that comprises a notch; and,
said first hook is engaged with said notch and said linear segment at the free end of the hook lies flat against the turned-in end wall portion.

12. The lid hinge assembly as set forth in claim 11, wherein said turned-in end wall portion is arranged at an oblique angle with respect to said main wall such that the turned-in end wall portion is arranged obliquely with respect to the main wall whereby an obtuse angle is defined between the turned-in end wall portion and the main wall when measured in the space defined between the upper and lower flanges and the turned-in end wall portion.

13. The lid hinge as set forth in claim 3, wherein said spring comprises a convex barrel spring.

14. The lid hinge as set forth in claim 3, wherein said cam arm comprises an aperture and wherein said second end of said spring comprises a hook that is engaged with the aperture of the cam arm.

15. The lid hinge as set forth in claim 1, wherein the cam rotates between a first angular position corresponding to a fully closed position of the associated appliance lid and an second angular position corresponding to a fully opened position of the associated appliance lid, and wherein said spring biases said cam toward a neutral angular position of the cam that is located between the first and second angular positions of the cam, said cam comprising a stop face that prevents angular movement of the cam in the first angular direction beyond the second angular position of the cam.

16. The lid hinge assembly as set forth in claim 1, wherein the cam comprises a one-piece polymeric structure.

17. The lid hinge assembly as set forth in claim 8, wherein the main wall and the upper and lower spaced-apart flanges define a spring-receiving space of the base in which said spring is located, wherein said main wall of said base includes at least one of: (i) a recess defined in an internal side that faces said spring to provide space for said spring adjacent said main wall; (ii) open slot that extends through said main wall adjacent said spring.

18. The lid hinge assembly as set forth in claim 1, further comprising a damper located on the base that is engaged by the cam to slow movement of the cam in said second angular direction corresponding to said pivoting closing movement of the associated appliance lid.

19. The lid hinge assembly as set forth in claim 18, wherein said base comprises a damper-receiving housing including a bore in which said damper cylinder body is slidably positioned, wherein said damper-receiving housing comprises either:
(i) a metallic housing structure defined as part of a one-piece structure together with said base;
(ii) a polymeric housing connected to said base;
(iii) one or more clips, rivets, bosses, or any other structure(s) connected to and/or formed as part of the channel and positioned to hold the damper D in its operative position on or relative to the base.

20. The lid hinge assembly as set forth in claim 18, wherein said cam engages said damper in an engagement position of said cam that is located angularly between a first operative position of said cam corresponding to a fully closed position of the associated appliance lid and a second operative position of said cam corresponding to a fully opened position of the associated appliance lid, and wherein angular movement of said cam in said second angular direction from said second operative position toward said first operative position is unaffected by said damper for at least part of an angular distance traveled by said cam from said second operative position toward said first operative position.
